(19) United States
(12) Patent Application Publication
(10) Pub. No.: US 2023/0213729 A1
(43) Pub. Date: Jul. 6, 2023

(54) CAMERA DEVICE ASSEMBLED WITH LENS-TO-SENSOR DISTANCE THAT REDUCES AUTO-FOCUSING ACTUATION POWER

(71) Applicant: META PLATFORMS TECHNOLOGIES, LLC, Menlo Park, CA (US)

(72) Inventors: Lidu Huang, Danville, CA (US); Honghong Peng, Mountain View, CA (US); Yizhi Xiong, Foster City, CA (US); Te Hu, Kirkland, WA (US)

(21) Appl. No.: 17/568,595

(22) Filed: Jan. 4, 2022

(51) Int. Cl. G02B 7/09; G02B 7/02; G03B 13/36

(52) U.S. Cl. CPC G02B 7/09; G02B 7/023; G02B 7/028; G03B 13/36

(57) ABSTRACT

Embodiments of the present disclosure relate to a camera device assembled to reduce an auto-focusing actuation power for the most typical use case. The camera device comprises an image sensor and a lens assembly in an optical series with the image sensor. During assembling of the camera device, the lens assembly is assembled within the camera device to have an optical axis parallel to gravity and positioned to have an offset along the optical axis relative to a support assembly. The offset is determined during assembling of the camera device such that, when the camera device is oriented with a rotated optical axis orthogonal to gravity, the lens assembly is positioned at a neutral position relative to the image sensor without activation applied to the lens assembly.

### FIELD OF THE INVENTION

The present disclosure relates generally to assembling of a camera device, and specifically relates to a camera device assembled with a specific lens-to-sensor distance that reduces an auto-focusing actuation power.

### BACKGROUND

It is desired that for the most typical use case of a camera device, a lens in the camera device is at its near hyperfocal position relative to an image sensor so that a minimum (e.g., zero-level or near zero-level) auto-focusing actuation power is consumed for focusing of the lens. In the most typical use case of the camera device, the camera device is facing forward with its lens in horizontal posture in optical series with the image sensor. However, when the lens is in the horizontal posture, the lens is typically not at its hyperfocal position. There are two primary causes that affect a distance between the lens and the image sensor in the camera device, which then affect a level of auto-focusing actuation power consumed to bring the lens in its hyperfocal position. The first cause is movement of the lens (i.e., auto-focusing actuator movement) between an upward (vertical) posture of the lens and a forward (horizontal) posture of the lens. The lens is typically combined with a carrier, and, at the upward posture of the camera device, the carrier is shifted downward due to gravity. The second cause is a thermal shift of the lens during typical operations of the camera device. The lens design and its performance are commonly tested at a room temperature, e.g., around 23° C. However, the camera device can often operate at higher temperatures (e.g., around 45 to 50° C.) when placed inside an electronic wearable device (e.g., smartwatch). The higher temperatures of an interior of the electronic wearable device may cause additional shifting (i.e., thermal shifting) of the camera lens relative to the image sensor as well as a modified (e.g., longer) focal distance of the camera lens due to a change of the camera lens shape.

### SUMMARY

Embodiments of the present disclosure relate to a camera device assembled such that to reduce (and in some cases minimize) auto-focusing actuation power for the most typical use case of the camera device. The camera device comprises an image sensor and a lens assembly in an optical series with the image sensor. During assembling of the camera device, the lens assembly is assembled within the camera device to have an optical axis parallel to gravity and positioned to have an offset along the optical axis relative to a support assembly. The offset is determined during assembling of the camera device such that, when the camera device is oriented with a rotated optical axis orthogonal to gravity, the lens assembly is positioned at a neutral position relative to the image sensor without activation applied to the lens assembly. The camera device may be part of a wristband system, e.g., a smartwatch or some other electronic wearable device.

Embodiments of the present disclosure further relate to a method of assembling a camera device to reduce (and in some cases minimize) an auto-focusing actuation power for the most typical use case of the camera device. The method comprises: assembling a lens assembly within the camera device to have an optical axis parallel to gravity, determining an offset of the lens assembly along the optical axis relative to a support assembly such that, when the camera device is oriented with a rotated optical axis orthogonal to gravity, the lens assembly is positioned at a neutral position relative to the image sensor without activation applied to the lens assembly, and positioning the lens assembly within the camera device to be in an optical series with an image sensor of the camera device and to have the determined offset along the optical axis.

### BRIEF DESCRIPTION OF THE DRAWINGS

FIG. 1A is a top view of an example wristband system, in accordance with one or more embodiments.

FIG. 1B is a side view of the example wristband system of FIG. 1A.

FIG. 2 is a perspective view of another example wristband system, in accordance with one or more embodiments.

FIG. 3 is a cross section of an example structure of a camera device, in accordance with one or more embodiments.

FIG. 4A is a cross section of an example shield case of a camera device during assembling of the camera device, in accordance with one or more embodiments.

FIG. 4B is an example cross section of the camera device with a lens assembly during assembling of the camera device, in accordance with one or more embodiments.

FIG. 4C is a cross section of the camera device having the lens assembly assembled in an upward (vertical) posture and aligned with an image sensor during assembling of the camera device, in accordance with one or more embodiments.

FIG. 4D is a cross section of the camera device with the lens assembly in a forward (horizontal) posture when the camera device is fully assembled, in accordance with one or more embodiments.

FIG. 5 is a graph illustrating a thermal shift of a lens assembly in a camera device as a function of an operating temperature of the camera device, in accordance with one or more embodiments.

FIG. 6 is a flowchart illustrating a process of assembling a camera device to have a specific distance between a lens assembly and an image sensor that reduces an auto-focusing actuation power, in accordance with one or more embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Embodiments of the present disclosure relate to a camera device with a lens assembly assembled with a predetermined offset along an optical axis in an upward (or vertical) posture of the camera device such that the lens assembly with a small amount of actuation or no amount of activation is at a target position in a forward (or horizontal) posture of the camera device where the lens assembly is focused at a hyperfocal distance. The camera device may be part of an electronic wearable device (e.g., a smartwatch). The camera device is assembled with the optical axis being substantially parallel to gravity (i.e., the lens is at the upward posture). During assembling of the camera device, the lens assembly is positioned (i.e., the offset is introduced) within the camera device, such that, during operation while the camera is poised (i.e., oriented with an optical axis orthogonal to gravity) to take an image of a local area, the lens assembly with a small amount of activation or no amount of actuation is positioned at a neutral position. During assembling of the camera device, the lens assembly was positioned within the camera device such that the neutral position corresponds to the target position where the lens assembly is focused at the hyperfocal distance. Moreover, the positioning of the lens assembly during assembling of the camera device may also account for thermal effects of operation of the camera device, such that the target position is calibrated to occur over a specific temperature range.

Embodiments of the present disclosure further relate to a method for lens assembly position control for achieving a least actuation power consumption (e.g., zero-level actuation power) when (i) a camera device is in its most typical use posture (i.e., horizontal posture of the camera device and the lens assembly); and (ii) the camera device is operating at higher temperatures (e.g., around 45° C. to 50° C., which is a typical ambient condition for the camera device inside an electronic wearable device). For these two combined use cases, a reduced level (e.g., zero-level) of auto-focusing actuation force is applied to focus the lens assembly at a hyperfocal distance for the most typical use posture (i.e., horizontal or forward posture) of the camera device and the lens assembly.

The camera device may be incorporated into a small form factor electronic device, such as an electronic wearable device. Examples of electronic wearable devices include a smartwatch or a head-mount display (HMD). The electronic device can include other components (e.g., haptic devices, speakers, etc.). And, the small form factor of the electronic device provides limited space between the other components and the camera device. In some embodiments, the electronic device may have limited power supply (e.g., due to being dependent on a re-chargeable battery).

In some embodiments, the electronic wearable device may operate in an artificial reality environment (e.g., a virtual reality environment). The camera device of the electronic wearable device may be used to enhance an artificial reality application running on an artificial reality system (e.g., running on an HMD device worn by the user). The camera device may be disposed on multiple surfaces of the electronic wearable device such that data from a local area, e.g., surrounding a wrist of the user, may be captured in multiple directions. For example, one or more images may be captured describing the local area and the images may be sent and processed by the HMD device prior to be presented to the user.

Embodiments of the present disclosure may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to create content in an artificial reality and/or are otherwise used in an artificial reality. The artificial reality system that provides the artificial reality content may be implemented on various platforms, including an electronic wearable device (e.g., headset) connected to a host computer system, a standalone electronic wearable device (e.g., headset, smartwatch, bracelet, etc.), a mobile device or computing system, or any other hardware platform capable of providing artificial reality content to one or more viewers.

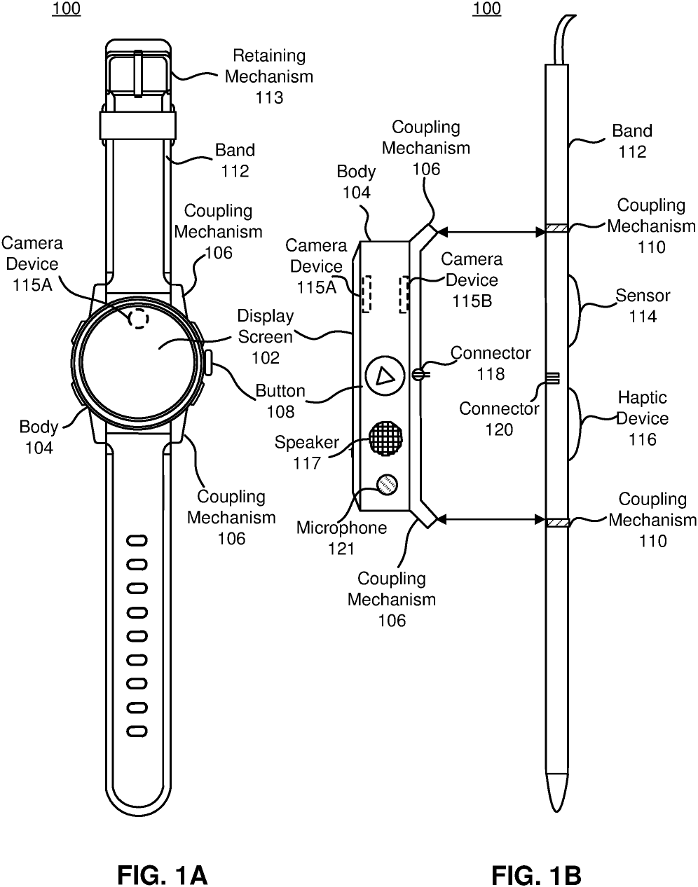

FIG. 1A is a top view of an example wristband system 100, in accordance with one or more embodiments. FIG. 1B is a side view of the example wristband system 100 of FIG. 1A. The wristband system 100 is an electronic wearable device and may be worn on a wrist or an arm of a user. In some embodiments, the wristband system 100 is a smartwatch. Media content may be presented to the user wearing the wristband system 100 using a display screen 102 and/or one or more speakers 117. However, the wristband system 100 may also be used such that media content is presented to a user in a different manner (e.g., via touch utilizing a haptic device 116). Examples of media content presented by the wristband system 100 include one or more images, video, audio, or some combination thereof. The wristband system 100 may operate in an artificial reality environment (e.g., a virtual reality environment, an augmented reality environment, a mixed reality environment, or some combination thereof).

In some examples, the wristband system 100 may include multiple electronic devices (not shown) including, without limitation, a smartphone, a server, a head-mounted display (HMD), a laptop computer, a desktop computer, a gaming system, Internet of things devices, etc. Such electronic devices may communicate with the wristband system 100 (e.g., via a personal area network). The wristband system 100 may have sufficient processing capabilities (e.g., CPU, memory, bandwidth, battery power, etc.) to offload computing tasks from each of the multiple electronic devices to the wristband system 100. Additionally or alternatively, each of the multiple electronic devices may have sufficient processing capabilities (e.g., CPU, memory, bandwidth, battery power, etc.) to offload computing tasks from the wristband system 100 to the electronic device(s).

The wristband system 100 includes a watch body 104 coupled to a watch band 112 via one or more coupling mechanisms 106, 110. The watch body 104 may include, among other components, one or more coupling mechanisms 106, one or more camera devices 115 (e.g., camera device 115A and 115B), the display screen 102, a button 108, a connector 118, a speaker 117, and a microphone 121. The watch band 112 may include, among other components, one or more coupling mechanisms 110, a retaining mechanism 113, one or more sensors 114, the haptic device 116, and a connector 120. While FIGS. 1A and 1B illustrate the components of the wristband system 100 in example locations on the wristband system 100, the components may be located elsewhere on the wristband system 100, on a peripheral electronic device paired with the wristband system 100, or some combination thereof. Similarly, there may be more or fewer components on the wristband system 100 than what is shown in FIGS. 1A and 1B. For example, in some embodiments, the watch body 104 may include a port for connecting the wristband system 100 to a peripheral electronic device and/or to a power source. The port may enable charging of a battery of the wristband system 100 and/or communication between the wristband system 100 and a peripheral device. In another example, the watch body 104 may include an inertial measurement unit (IMU) that measures a change in position, an orientation, and/or an acceleration of the wristband system 100. The IMU may include one or more sensors, such as one or more accelerometers, one or more gyroscopes, one or more magnetometers, another suitable type of sensor that detects motion, a type of sensor used for error correction of the IMU, or some combination thereof.

The watch body 104 and the watch band 112 may have any size and/or shape that is configured to allow a user to wear the wristband system 100 on a body part (e.g., a wrist). The wristband system 100 may include the retaining mechanism 113 (e.g., a buckle) for securing the watch band 112 to the wrist of the user. The coupling mechanism 106 of the watch body 104 and the coupling mechanism 110 of the watch band 112 may attach the watch body 104 to the watch band 112. For example, the coupling mechanism 106 may couple with the coupling mechanism 110 by sticking to, attaching to, fastening to, affixing to, some other suitable means for coupling to, or some combination thereof.

The wristband system 100 may perform various functions associated with the user. The functions may be executed independently in the watch body 104, independently in the watch band 112, and/or in communication between the watch body 104 and the watch band 112. In some embodiments, a user may select a function by interacting with the button 108 (e.g., by pushing, turning, etc.). In some embodiments, a user may select a function by interacting with the display screen 102. For example, the display screen 102 is a touchscreen and the user may select a particular function by touching the display screen 102. The functions executed by the wristband system 100 may include, without limitation, displaying visual content to the user (e.g., displaying visual content on the display screen 102), presenting audio content to the user (e.g., presenting audio content via the speaker 117), sensing user input (e.g., sensing a touch of button 108, sensing biometric data with the one or more sensors 114, sensing neuromuscular signals with the one or more sensors 114, etc.), capturing audio content (e.g., capturing audio with microphone 121), capturing data describing a local area (e.g., with a front-facing camera device 115A and/or a rear-facing camera device 115B), communicating wirelessly (e.g., via cellular, near field, Wi-Fi, personal area network, etc.), communicating via wire (e.g., via the port), determining location (e.g., sensing position data with a sensor 114), determining a change in position (e.g., sensing change(s) in position with an IMU), determining an orientation and/or acceleration (e.g., sensing orientation and/or acceleration data with an IMU), providing haptic feedback (e.g., with the haptic device 116), etc.

The display screen 102 may display visual content to the user. The displayed visual content may be oriented to the eye gaze of the user such that the content is easily viewed by the user. Traditional displays on wristband systems may orient the visual content in a static manner such that when a user moves or rotates the wristband system, the content may remain in the same position relative to the wristband system causing difficulty for the user to view the content. The displayed content may be oriented (e.g., rotated, flipped, stretched, etc.) such that the displayed content remains in substantially the same orientation relative to the eye gaze of the user (e.g., the direction in which the user is looking). The displayed visual content may also be modified based on the eye gaze of the user. For example, in order to reduce the power consumption of the wristband system 100, the display screen 102 may dim the brightness of the displayed content, pause the displaying of video content, or power down the display screen 102 when it is determined that the user is not looking at the display screen 102. In some examples, one or more sensors 114 of the wristband system 100 may determine an orientation of the display screen 102 relative to an eye gaze direction of the user.

The position, orientation, and/or motion of eyes of the user may be measured in a variety of ways, including through the use of optical-based eye-tracking techniques, infraredbased eye-tracking techniques, etc. For example, the front-facing camera device 115A and/or rear-facing camera device 115B may capture data (e.g., visible light, infrared light, etc.) of the local area surrounding the wristband system 100 including the eyes of the user. The captured data may be processed by a controller (not shown) internal to the wristband system 100, a controller external to and in communication with the wristband system 100 (e.g., a controller of an HMD), or a combination thereof to determine the eye gaze direction of the user. The display screen 102 may receive the determined eye gaze direction and orient the displayed content based on the eye gaze direction of the user.

In some embodiments, the watch body 104 may be communicatively coupled to an HMD. The front-facing camera device 115A and/or the rear-facing camera device 115B may capture data describing the local area, such as one or more wide-angle images of the local area surrounding the front-facing camera device 115A and/or the rear-facing camera device 115B. The wide-angle images may include hemispherical images (e.g., at least hemispherical, substantially spherical, etc.), 180-degree images, 360-degree area images, panoramic images, ultra-wide area images, or a combination thereof. In some examples, the front-facing camera device 115A and/or the rear-facing camera device 115B may be configured to capture images having a range between 45 degrees and 360 degrees. The captured data may be communicated to the HMD and displayed to the user on a display screen of the HMD worn by the user. In some examples, the captured data may be displayed to the user in conjunction with an artificial reality application. In some embodiments, images captured by the front-facing camera device 115A and/or the rear-facing camera device 115B may be processed before being displayed on the HMD. For example, certain features and/or objects (e.g., people, faces, devices, backgrounds, etc.) of the captured data may be subtracted, added, and/or enhanced before displaying on the HMD.

In accordance with embodiments of the present disclosure, components of the front-facing camera device 115A and the rear-facing camera device 115B are assembled such that the front-facing camera device 115A and the rear-facing camera device 115B are capable of taking pictures capturing data describing the local area. At least one lens of the front-facing camera device 115A and at least one lens of the rear-facing camera device 115B can be automatically positioned at their target positions. A target position in a forward (or horizontal) posture of the front-facing camera device 115A may correspond to a position at which the at least one lens of the front-facing camera device 115A is focused at its preferred focal distance (e.g., distance in the order of several decimeters). A target position in a forward (or horizontal) posture of the rear-facing camera device 115B may correspond to a position at which the at least one lens of the rear-facing camera device 115B is focused at its hyperfocal distance in the local area (e.g., distance of approximately 1.7 meter).

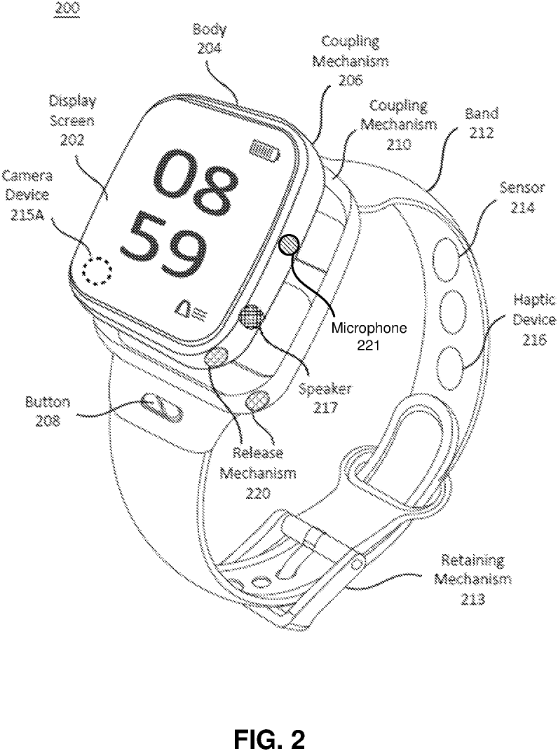

FIG. 2 is a perspective view of another example wristband system 200, in accordance with one or more embodiments. The wristband system 200 includes many of the same components described above with reference to FIGS. 1A and 1B, but a design or layout of the components may be modified to integrate with a different form factor. For example, the wristband system 200 includes a watch body 204 of a different shape and a watch band 212 with a different layout of components (e.g., a different location for a sensor 214 and a haptic device 216 on the watch band 212). FIG. 2 illustrates a coupling mechanism 206, a camera device 215A, a display screen 202, a button 108, a speaker 117, a microphone 221, and a release mechanism 220 associated with the watch body 204. FIG. 2 further illustrates a coupling mechanism 210, a retaining mechanism 213, the sensor 114, the haptic device 116, and a release mechanism 220 associated with the watch band 212. In some embodiments, another camera device may be located on an underside of the watch body 204 and is not shown in FIG. 2. In some embodiments, one or more additional sensors 214 (not shown) may be included on the watch body 204 or the watch band 212. As the wristband system 100 and the wristband system 200 are of a small form factor to be easily and comfortably worn on a wrist of a user, the corresponding camera devices 115, 215 and various other components of the wristband system 100 described above are designed to be of an even smaller form factor and are positioned close to each other.

In accordance with embodiments of the present disclosure, components of the camera device 215 are assembled such that when the camera device 215 is at the forward (horizontal) posture to take a picture capturing data describing the local area, a lens of the camera device 215 is automatically positioned (e.g., with no amount of activation power) at a target position. The target position in the forward (or horizontal) posture of the camera device 215 corresponds to a position at which the lens of the camera device 215 is focused at a hyperfocal distance in the local area.

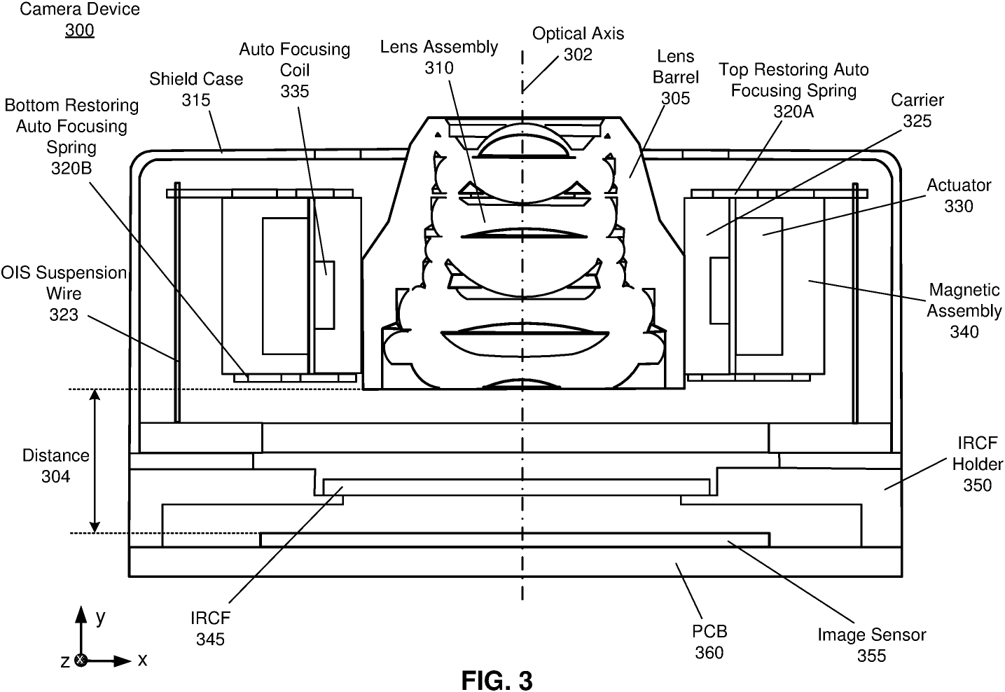

FIG. 3 is a cross section of an example structure of a camera device 300, in accordance with one or more embodiments. The camera device 300 may be an embodiment of the camera devices 115, 215. The camera device 300 may capture data (e.g., one or more images) of a local area surrounding the camera device 300. The camera device 300 shown in FIG. 3 includes a lens barrel 305, a lens assembly 310, a shield case 315, one or more top restoring auto focusing springs 320A, one or more bottom restoring auto focusing springs 320B, one or more optical image stabilization (OIS) suspension wires 323, a carrier 325, one or more actuators 330, one or more auto focusing coils 335, a magnetic assembly 340, an infrared cut-off filter (IRCF) 345, an IRCF holder 350, an image sensor 355, and a printed circuit board (PCB) 360. The one or more top restoring auto focusing springs 320A together with the one or more bottom restoring auto focusing springs 320B are collectively referred to herein as “one or more restoring auto focusing springs 320.” In alternative configurations, different and/or additional components may be included in the camera device 300. For example, in some embodiments, the camera device 300 may include a controller (not shown in FIG. 3). In alternative embodiments, the controller may be part of some other system (e.g., a wristband system the camera device 300 is coupled to).

The camera device 300 is configured to have both a focusing assembly and a stabilization assembly. The focusing assembly is configured to cause a translation of the lens barrel 305 in a direction parallel to an optical axis 302 of the lens assembly 310. The focusing assembly provides an auto focus functionality for the camera device 300. The focusing assembly includes the one or more restoring auto focusing springs 320, the one or more OIS suspension wires 323, and a plurality of magnets included in the magnetic assembly 340. The stabilization assembly is configured to cause a translation of the lens barrel 305 (and, in some embodiments, the magnetic assembly 340 and the lens barrel 305) in one or more directions perpendicular to the optical axis 302. The stabilization assembly provides an OIS functionality for the camera device 300 by stabilizing an image projected through the lens barrel 305 to the image sensor 355. The stabilization assembly includes the lens barrel 305, the shield case 315, and the magnetic assembly 340.

The lens barrel 305 is a mechanical structure or housing for carrying one or more lenses of the lens assembly 310. The lens barrel 305 is a hollow structure with an opening on opposite ends of the lens barrel 305. The openings may provide a path for light (e.g., visible light, infrared light, etc.) to transmit between a local area and the image sensor 355. Inside the lens barrel 305, one or more lenses of the lens assembly 310 are positioned between the two openings. The lens barrel 305 may be manufactured from a wide variety of materials ranging from plastic to metals. In some embodiments, one or more exterior surfaces of the lens barrel 305 are coated with a polymer (e.g., a sub-micron thick polymer). The lens barrel 305 may be rotationally symmetric about the optical axis 302 of the one or more lenses of the lens assembly 310.

The lens barrel 305 may be coupled to the magnetic assembly 340 by the one or more restoring auto focusing springs 320. For example, the one or more restoring auto focusing springs 320 are coupled to the lens barrel 305 and the magnetic assembly 340. In some embodiments, the magnetic assembly 340 is coupled to the shield case 315. In another example (not illustrated), the one or more restoring auto focusing springs 320 are coupled to the shield case 315 directly and the lens barrel 305. The one or more restoring auto focusing springs 320 are configured to control a positioning of the lens barrel 305 along the optical axis 302. For example, the plurality of restoring auto focusing springs 320 may control the positioning of the lens barrel 305 such that when current is not supplied to the one or more auto focusing coils 335 the lens barrel 305 is in a neutral position. In some embodiments, the one or more restoring auto focusing springs 320 may be shape-memory alloy (SMA) wires. The neutral position of the lens barrel 305 is a positioning of the lens barrel 305 when the camera device 300 is not undergoing focusing (via the focusing assembly) nor stabilizing (via the stabilization assembly). The one or more restoring auto focusing springs 320 can ensure the lens barrel 305 does not fall out or come into contact with the image sensor 355. In some embodiments, the one or more restoring auto focusing springs 320 are conductors and may be coupled to the one or more auto focusing coils 335. In these embodiments, the plurality of restoring auto focusing springs 320 may be used to provide current to the one or more auto focusing coils 335. The one or more restoring auto focusing springs 320 may be coupled to the one or more OIS suspension wires 323 that provide current to the one or more restoring auto focusing springs 320 so that the one or more restoring auto focusing springs 320 can facilitate auto focusing of the lens assembly 310. The one or more OIS suspension wires 323 may be positioned symmetrically about the optical axis 302.

The shield case 315 may enclose some of the components of the camera device 300 as illustrated in FIG. 3. In other embodiments (not shown), the shield case 315 may encloses all of the components of the camera device 300. As illustrated in FIG. 3A, the shield case 315 partially encloses the lens barrel 305. The shield case 315 provides a space in which the lens barrel 305 can translate along the optical axis 302 and/or translate in a direction perpendicular to the optical axis 302. In some embodiments, the shield case 315 provides a space in which the lens barrel 305 rotates relative to one or more axes that are perpendicular to the optical axis 302. In some embodiments, the shield case 315 may be rectangular-shaped as illustrated. In alternative embodiments, the shield case 315 may be circular, square, hexagonal, or any other shape. In embodiments where the camera device 300 is part of another electronic device (e.g., a smartwatch), the shield case 315 may couple to (e.g., be mounted on, affixed to, attached to, etc.) another component of the electronic device, such as a frame of the electronic device. For example, the shield case 315 may be mounted on a watch body (e.g., the watch body 104) of the smartwatch. The shield case 315 may be manufactured from a wide variety of materials ranging from plastic to metals. In some examples, the shield case 315 is manufactured from a same material as the material of the electronic device the shield case 315 is coupled to such that the shield case 315 is not distinguishable from the rest of the electronic device. In some embodiments, the shield case 315 is manufactured from a material that provides a magnetic shield to surrounding components of the electronic device. In these embodiments, the shield case 315 may be a shield can. In some embodiments, one or more interior surfaces of the shield case 315 are coated with a polymer similar to the lens barrel 305 described above.

The carrier 325 is directly coupled to the lens barrel 305. For example, the carrier 325 comprises a first side in direct contact with a surface of the lens barrel 305 and a second side opposite the first side. In some embodiments, the carrier 325 is coupled to the lens barrel 305 by an adhesive. The one or more auto focusing coils 335 may be affixed to the second side of the carrier 325. The carrier 325 has a curvature that conforms to the curvature of the lens barrel 305. In some embodiments, more than one carrier 325 may be directly coupled to the lens barrel 305. In these embodiments, the number of carriers 325 may match a number of auto focusing coils 335 and the carriers 325 may be positioned at unique locations around the lens barrel 305 such that a carrier 325 is positioned between a corresponding auto focusing coil 335 and the lens barrel 305. In some embodiments, the restoring auto focusing springs 320 may be coupled to the carrier 325.

The one or more auto focusing coils 335 are configured to conduct electricity by being supplied with a current. The one or more auto focusing coils 335 may be positioned symmetrically about the optical axis 302. For example, the one or more auto focusing coils 335 may consist of two individual coils positioned symmetrically about the optical axis 302, as illustrated in FIG. 3. The one or more auto focusing coils 335 are coupled to the one or more actuators 330 and provide the current to the one or more actuators 330.

The one or more actuators 330 are configured to provide auto focusing to the one or more lenses of the lens assembly 310. The one or more actuators 330 consume an auto focusing actuation power while providing auto focusing to the one or more lenses of the lens assembly 310. To reduce (and in some cases minimize) a level of the auto focusing actuation power consumption (e.g., to achieve the zero level auto focusing actuation power), relative positions of the lens assembly, the carrier 325 and the one or more actuators 330 along the optical axis 302 are controlled during assembling of the camera device 300. During assembling of the camera device 300, the relative positions of the lens assembly 310, the carrier 325 and the one or more actuators 330 along the optical axis 302 may be controlled by using a lens spacer (not shown in FIG. 3). The lens spacer may be configured to hold the one or more lenses of the lens assembly 310 in place when the lens assembly 310 and the lens barrel 305 are ready to be bonded to the carrier 325 during assembling of the camera device 300.

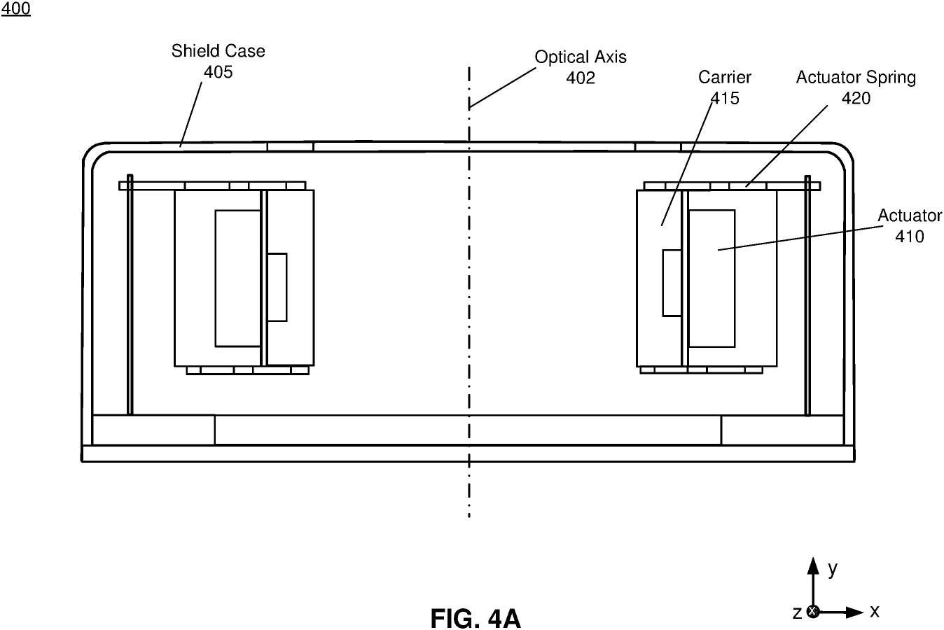

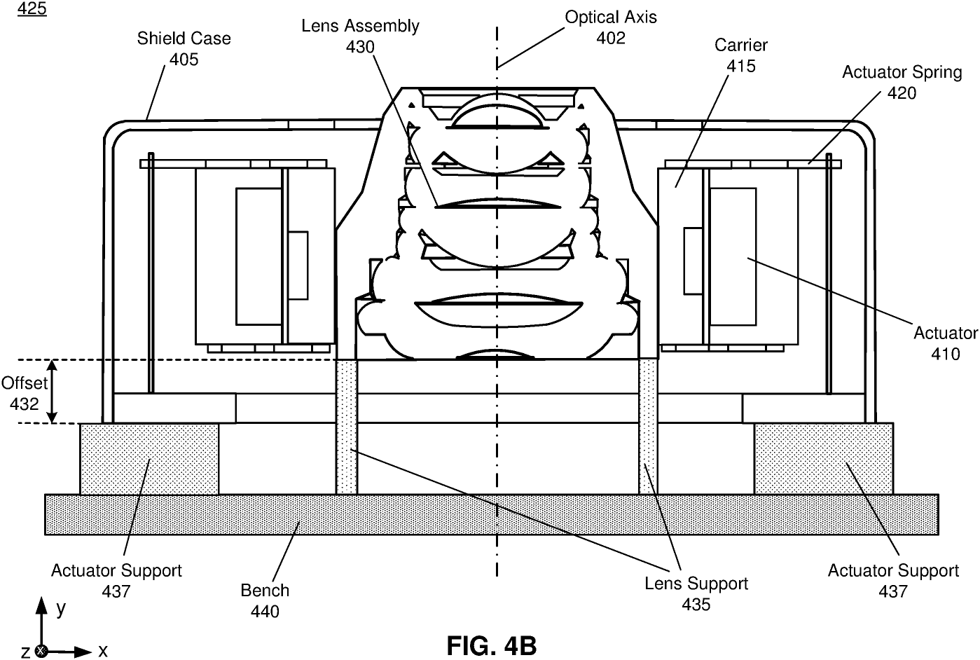

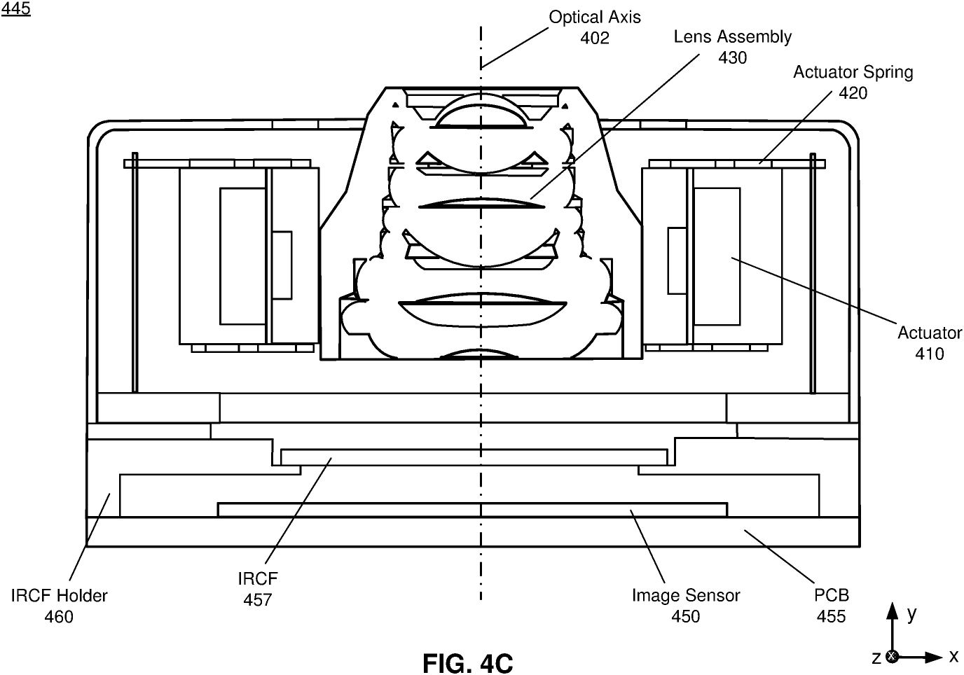

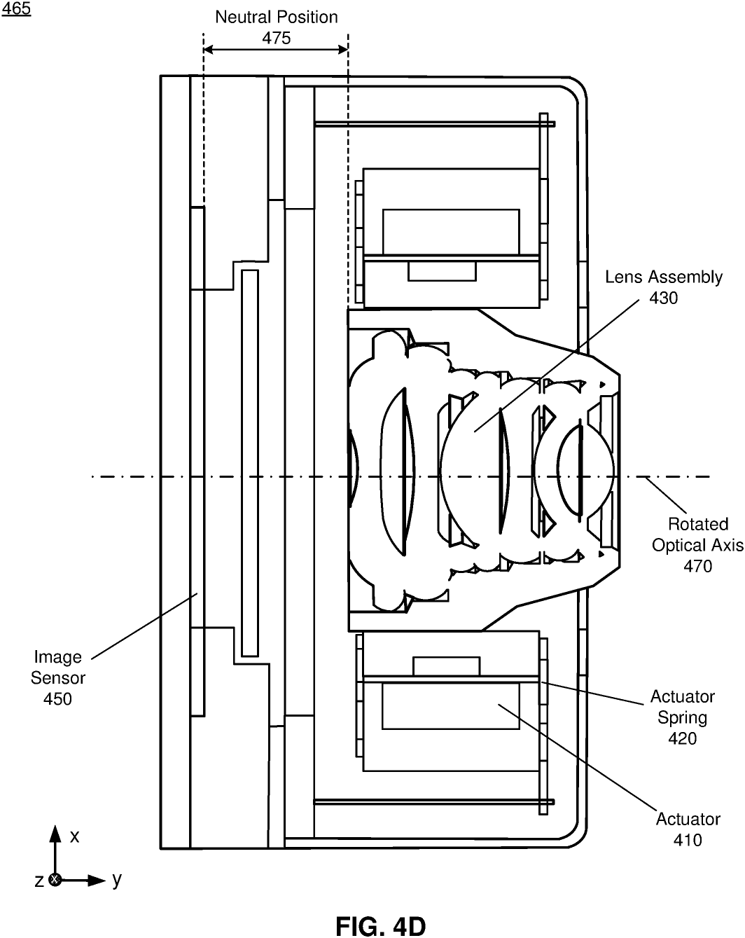

A relative position of the lens assembly 310 along the optical axis 302 may be determined during assembling of the camera device 300 by following variables. The first variable may be related to an effective back focal length (BFL) of the lens assembly 310. The effective BFL of the lens assembly 310 may depend on a distance from each lens in the lens assembly 310 to the image sensor 355. The effective BFL of the lens assembly 310 can be defined by design of each individual lens in the lens assembly 310. The second variable may be related to a displacement of the carrier 325 under gravity at the upright posture of the camera device 300, i.e., the posture of the camera device 300 as illustrated in FIG. 3. The carrier 325 moves downward under gravity during assembling of the camera device 300 with the actuator 330 being at an upward (or vertical) posture. The displacement of the carrier 325 under gravity may be determined by a weight of the carrier 325 and a stiffness of the one or more restoring auto focusing springs 320. The third variable may be related to a springback displacement of the lens assembly 310 and the carrier 325 at the most typical use posture of the camera device 300 (i.e., the forward or horizontal posture as shown in FIG. 4D) when the one or more lenses of the lens assembly 310 are in the forward (horizontal) posture. In such case, the lens assembly 310 moves away from the image sensor 355 due to an actuator spring force. The springback displacement may be determined by a weight of the actuator 330, and a spring constant of the one or more restoring auto focusing springs 320. The fourth variable may be related to a thermal shift of the one or more lenses of the lens assembly 310 at an expected operating temperature of the camera device 300. The expected operating temperature of the camera device 300 is typically elevated when the camera device 300 operates inside an electronic wearable device (e.g., a smartwatch). The fifth variable may be related to a modified (e.g., longer) focal distance of the one or more lenses of the lens assembly 310 due to a change of shape(s) of the one or more lenses caused by the elevated operating temperature of the camera device 300.

There are two primary causes affecting actuation power consumption in order to bring the lens assembly 310 at a hyperfocal position within the camera device 300 when the camera device 300 is at its forward (horizontal) posture: (i) a movement of the camera device 300 from an upward (vertical) posture to a forward (horizontal) posture; and (ii) a thermal shift of the one or more lenses of the lens assembly 310 at an expected operating temperature of the camera device 300 within an electronic wearable device. The upward (vertical) posture of the camera device 300 corresponds to a posture of the camera device 300 where the optical axis 302 is substantially parallel to gravity (e.g., parallel to y axis in FIG. 3). The forward (horizontal) posture of the camera device 300 corresponds to a posture of the camera device 300 with a rotated optical axis substantially perpendicular to the optical axis 302 (i.e., parallel to x axis in FIG. 3). The hyperfocal position of the lens assembly 310 corresponds to a position of the lens assembly 310 within the camera device 300 at which the lens assembly 310 is focused at a hyperfocal distance within a local area (e.g., 1.7 meter) when the camera device 300 is at the forward posture.

Embodiments of the present disclosure relate to assembling the camera device 300 in order to achieve a specific distance 304 between the lens assembly 310 and the image sensor 355 along the optical axis 302, when the camera device 300 is at the upward posture. By setting the distance 304 during assembling of the camera device 300, the lens assembly 310 is at the hyperfocal position while consuming an auto focusing actuation power below a defined threshold level when the camera device 300 is at the forward posture. In some embodiments, when the camera device 300 is at the forward posture, the lens assembly 310 is automatically at the hyperfocal position without consuming any auto focusing actuation power. The distance 304 between the lens assembly 310 and the image sensor 355 can be defined as a distance along the optical axis 302 between a surface of the image sensor 355 oriented toward the lens assembly 310 and a surface of a lens in the lens assembly 310 nearest to the surface of the image sensor 355. The specific value of the distance 304 can be determined during assembling of the camera device 300 by considering: (i) a posture difference of the actuator 330 with and without the lens assembly 310; and (ii) a thermal shift the one or more lenses of the lens assembly 310 assuming a typical system interior temperature near the camera device 300 in the range of approximately, e.g., 40° C. to 50° C.

The magnetic assembly 340 includes a magnet holder for holding a plurality of magnets. The magnet holder may provide a rigid structure to support the plurality of magnets. In some embodiments, the magnet holder may enclose all sides of the magnets. In other embodiments, the magnet holder may enclose all sides of the magnets except for a side facing the one or more auto focusing coils 335. In some embodiments, one or more exterior surfaces of the magnetic assembly 340 are coated with a polymer similar to the lens barrel 305 described above.

The plurality of magnets of the magnetic assembly 340 generate magnetic fields that can be used for translating the lens barrel 305 along the optical axis 302 (e.g., focusing the camera device 300) and/or perpendicular to the optical axis 302 (e.g., providing OIS for the camera device 300). The magnetic fields used for focusing the camera device 300 can be applied in the forward (horizontal) posture of the camera device 300, e.g., to focus the lens assembly 310 at the hyperfocal distance without consuming any auto focusing actuation power.

Each magnet of the plurality of magnets may be a different size or the same size. In some embodiments, each magnet is curved about the optical axis 302 conforming to the curvature of the one or more auto focusing coils 335 and the lens barrel 305. In some embodiments, each magnet is straight. For example, at least two opposing sides of each magnet are parallel to a plane that is parallel to the optical axis 302. Each magnet of the plurality of magnets may include rectangular cross sections with one axis of a cross section being parallel to the optical axis 302 and another axis of the cross section being perpendicular to the optical axis 302. In some embodiments, each magnet may include other types of cross sectionals shapes such as square or any other shape that includes at least one straight-edged side that faces the one or more auto focusing coils 335. Each magnet is a permanent magnet that is radially magnetized with respect to the optical axis 302. The magnets may be positioned symmetrically about the optical axis 302.

The image sensor 355 captures data (e.g., one or more images) describing a local area. The image sensor 355 may include one or more individual sensors, e.g., a photodetector, a CMOS sensor, a CCD sensor, some other device for detecting light, or some combination thereof. The individual sensors may be in an array. For a camera device 300 integrated into an electronic device, the local area is an area surrounding the electronic device. The image sensor 355 captures light from the local area. The image sensor 355 may capture visible light and/or infrared light from the local area surrounding the electronic device. The visible and/or infrared light is focused from the local area to the image sensor 355 via the lens barrel 305. The image sensor 355 may include various filters, such as the IRCF 345. The IRCF 345 is a filter configured to block the infrared light from the local area and propagate the visible light to the image sensor 355. The IRCF 345 may be placed within the IRCF holder 350.

The PCB 360 is positioned below the image sensor 355 along the optical axis 302. The PCB 360 is a stationary component of the camera device 300 and provides mechanical support (e.g., by acting as a base) for the camera device 300. The PCB 360 may provide electrical connections for one or more components of the camera device 300. In some embodiments, a controller may be located on the PCB 360 and the PCB 360 electrically connects the controller to various components (e.g., the one or more auto focusing coils 335) of the camera device 300. In other embodiments (not shown), the controller may be located in a different location within the camera device 300 or external to the camera device 300.

FIG. 4A is a cross section 400 of an example shield case 405 of a camera device during assembling of the camera device, in accordance with one or more embodiments. The shield case 405 may be an embodiment of the shield case 315 of the camera device 300 in FIG. 3. The shield case 405 in FIG. 4A is illustrated for the step of assembling the camera device prior to positioning of a lens barrel and a lens assembly within the camera device. As shown in FIG. 4A, an actuator 410 is in the upward (vertical) posture and ready for module assembly, i.e., assembling of a lens barrel (i.e., an embodiment of the lens barrel 310) and a lens assembly (i.e., an embodiment of the lens assembly 305). Note that a carrier 415 may be at a lower relative position along an optical axis 402 due to gravity. A displacement of the carrier 415 due to gravity may be determined by one or more features (e.g., a stiffness) of an actuator spring 420. The actuator 410, the carrier 415 and the actuator spring 420 may be embodiments of the actuator 330, the carrier 325, and the restoring auto focusing spring 320, respectively.

FIG. 4B is an example cross section 425 of the camera device with a lens assembly 430 during assembling of the camera device, in accordance with one or more embodiments. The lens assembly 430 may be an embodiment of the lens assembly 305. A specific height (e.g., an offset 432) of the lens assembly 430 along the optical axis 402 may be achieved during assembling of the camera device by using a support assembly. The support assembly may be configured as an assembly that supports the lens assembly 430, e.g., to hold one or more lenses of the lens assembly 430 in position for, e.g., glue bonding during assembling of the camera device. In one or more embodiments, the support assembly includes a lens support 435 and an actuator support 437 placed on top of a bench 440. Alternatively, the support assembly may include one or more additional or different components not shown in FIG. 4B. A cross section of the lens support 435 (not shown in FIG. 4B) may be cylindrically shaped (e.g., ring shaped), and a cross section of the actuator support 437 (not shown in FIG. 4B) may be rectangularly shaped.

The offset 432 may be defined as a distance between an inner surface of the actuator support 437 coupled to the shield case 405 and a surface of a lens in the lens assembly 430 closest to the inner surface of the actuator support 437. The amount of offset 432 may be controlled during assembling of the camera device based on specific heights of the lens support 435 and the actuator support 437 along the optical axis 402 The achieved offset 432 of the lens assembly 430 would reduce (and in some cases minimize) an auto-focusing actuation power for the most typical use case of the camera device, i.e., for forward (horizontal) posture of the camera device. In some embodiments, the offset 432 of the lens assembly 430 along the optical axis 402 is determined so that no auto-focusing actuation power is applied to focus the lens assembly 430 at the hyperfocal distance when the camera device is at the forward posture. In other words, by determining one or more specific heights of one or more components of the support assembly (e.g., the lens support 435 and the actuator support 437) along the optical axis 402 and setting the offset 432, the lens assembly 430 may be automatically in its hyperfocal position without applying any auto-focusing actuation power. The auto-focusing actuation power can be defined as a power consumed by the actuator 410 and the actuator spring 420 for moving the one or more lenses of the lens assembly 430 in order to bring the lens assembly 430 at the hyperfocal position within the camera device when the lens assembly 430 is in the horizontal (forward) posture having a rotated optical axis perpendicular to the optical axis 402 (i.e., perpendicular to gravity).

The offset 432 of the lens assembly 430 relative to the support assembly introduced during assembling of the camera device may provide that the lens assembly 430 would be at the hyperfocal position within the camera device while consuming an auto-focusing actuation power below a defined threshold level when the camera device and the lens assembly 430 are moved from the vertical (upward) posture to the horizontal (forward) posture. In some embodiments, the introduced offset 432 ensures that the lens assembly 430 is already at the hyperfocal position within the camera device without any consumption of the auto-focusing actuation power when the camera device is moved from the vertical posture to the horizontal posture. As discussed above, the introduced offset 432 may be determined during assembling of the camera device based on the following variables: (i) an effective BFL of the lens assembly 430; (ii) a displacement of the carrier 415 under gravity at the upright posture of the camera device; and (iii) a springback displacement of the lens assembly 430 and the carrier 415 at the most typical use posture (i.e., horizontal or forward posture) of the camera device; and (iv) a thermal shift of the one or more lenses of the lens assembly 430 at an expected operating temperature of the camera device within an electronic wearable device.

FIG. 4C is a cross section 445 of the camera device having the lens assembly 430 assembled in the upward posture and aligned with an image sensor 450 during assembling of the camera device, in accordance with one or more embodiments. The active alignment may be performed during this step of assembling the camera device to align an actuator assembly (i.e., the actuator 410 with the actuator spring 420) and the lens assembly 430 with a PCB sensor assembly (i.e., the image sensor 450 positioned on top of a PCB 455) and an IRCF 457 placed in an IRCF holder 460, e.g., to align various assemblies relative to the optical axis 402. The lens assembly 430 is positioned perpendicular to a plane of the image sensor 450. Additionally, the optical axis 402 of the lens assembly 430 is positioned at a geometrical center of the image sensor 450. The image sensor 450 and the PCB 455 may be embodiments of the image sensor 355 and the PCB 360, respectively. Additionally, the IRCF 457 and the IRCF holder 460 may be embodiments of the IRCF 345 and the IRCF holder 350, respectively.

FIG. 4D is a cross section 465 of the camera device with the lens assembly 430 in a forward (horizontal) posture when the camera device is fully assembled, in accordance with one or more embodiments. The cross section 465 of the camera device corresponds to the most typical use case of the camera device at which the one or more lenses of the lens assembly 430 are also in the horizontal posture. Note that, in the forward (horizontal) posture of the camera device and the lens assembly 430, the lens assembly 430 moves away from the image sensor 450 (along a rotated optical axis 470) by the actuator spring 420. The rotated optical axis 470 corresponds to an optical axis perpendicular to the optical axis 402 in FIGS. 4A-4C (i.e., orthogonal to gravity). The distance 304 in FIG. 3 set during assembling of the camera device may be determined such that, when the camera device is oriented with the rotated optical axis 470 along a defined direction (e.g., along y axis in FIG. 4D), the lens assembly 430 is positioned at a neutral position 475 relative to the image sensor 450 with a level of auto focusing activation power below a defined threshold level (e.g., the level of auto focusing activation power is zero-level). In some embodiments, the rotated optical axis 470 is orthogonal to gravity (e.g., gravity being oriented along x axis). The neutral position 475 may correspond to a target position of the lens assembly 430 at which the lens assembly 430 is focused at the hyperfocal distance within a local area surrounding the camera device. For example, the hyperfocal distance may be defined as a distance of approximately 1.7 meter, which corresponds to the most typical use case of the camera device when taking images of the local area. In some embodiments, the target position of the lens assembly 430 corresponds to some other focal position of the lens assembly 430 different than the hyperfocal position. Thus, in some embodiments, by setting the specific distance 304 during assembling of the camera device, no auto-focusing actuation power is consumed by the actuator 410 and the actuator spring 420 when the camera device is moved to the forward (horizonal) posture as the lens assembly 430 has already been positioned at the neutral position 475 (i.e., target position) relative to the image sensor 450 thus achieving a focus of the lens assembly 430 at the hyperfocal distance.

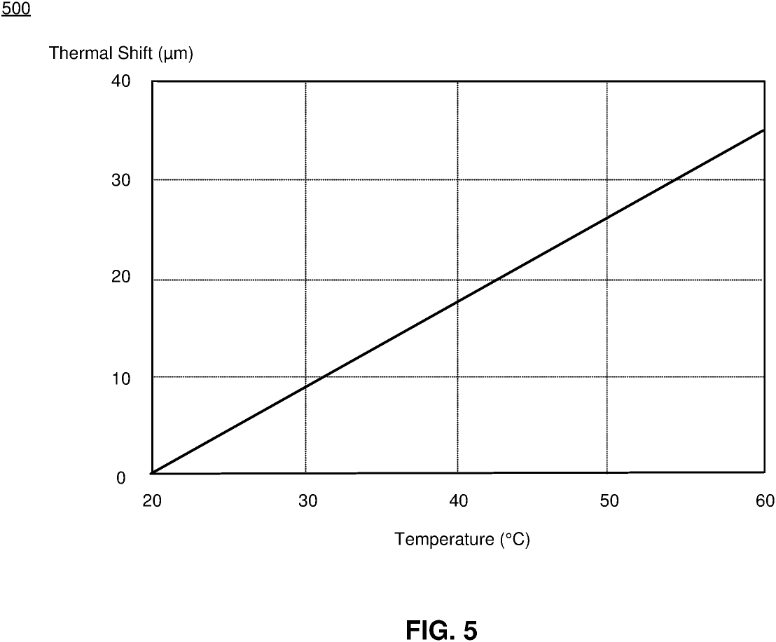

As aforementioned, positioning of a lens assembly during assembling of a camera device (e.g., the camera device 300) may also account for thermal effects of operation of the camera device, such that the target position of the lens assembly is calibrated to occur over a specific temperature range. FIG. 5 is a graph 500 illustrating a thermal shift of a lens assembly (e.g., the lens assembly 310 or the lens assembly 430) in a camera device (e.g., the camera device 300) as a function of an operating temperature of the camera device, in accordance with one or more embodiments. Typically, performance of the lens assembly in the camera device are tested at an ambient (room) temperature, e.g., at a temperature in a defined vicinity of 23° C. However, the camera device can commonly operate at higher temperatures inside an electronic wearable device (e.g., smartwatch), which leads to a thermal shift of the lens assembly. For example, it can be expected that the camera device operates inside the electronic wearable device at temperatures in a defined vicinity of 45° C. (e.g., 45° C. ± 5° C.). Based on the graph 500, it is therefore expected that the lens assembly moves approximately 20 µm away from an image sensor within the camera device during the typical use case of the camera device for the lens assembly to keep focus onto the image sensor. Therefore, during assembling the camera device, the expected thermal shift (e.g., of approximately 20 µm) may be considered when determining a distance (e.g., the distance 304) between the lens assembly and the image sensor. The distance may be increased by the expected thermal shift of the lens assembly relative to the image sensor (e.g., increased by approximately 20 µm).

Additionally, a focal distance of the lens assembly may be modified (e.g., become longer) as shape(s) of one or more lenses in the lens assembly may change due to higher operating temperatures of the camera device. The modified focal distance of the lens assembly at the higher operating temperatures may be considered when determining the distance between the lens assembly and the image sensor during assembling of the camera device. Thus, the distance may be additionally adjusted (e.g., increased) by a specific amount to counter the effect of a modified (e.g., longer) focal distance of the lens assembly 310 at the higher operating temperatures.

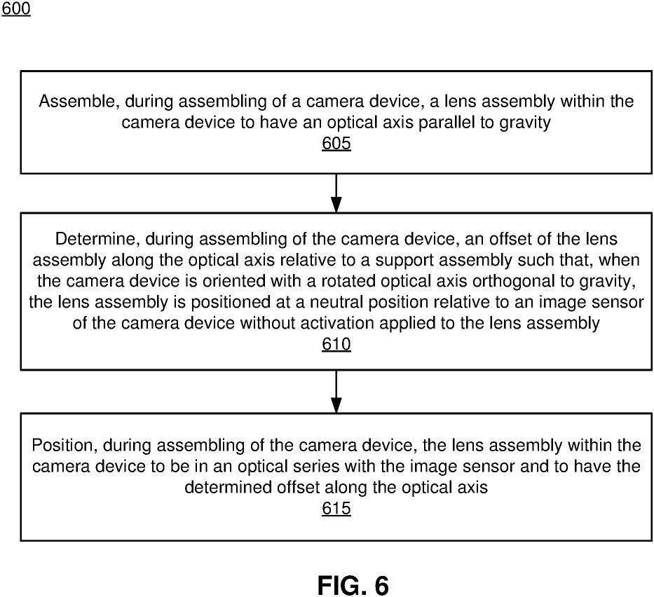

FIG. 6 is a flowchart illustrating a process 600 of assembling a camera device to have a specific distance between a lens assembly and an image sensor that reduces (and in some cases minimizes) an auto-focusing actuation power, in accordance with one or more embodiments. Steps of the process 600 of assembling the camera device may be performed by one or more components of a manufacturing system configured for assembling of the camera device. Embodiments may include different and/or additional steps of the process 600, or perform the steps of the process 600 in different orders.

At 605, during assembling of the camera device, the lens assembly is assembled within the camera device to have an optical axis parallel to gravity. In one embodiment, the lens assembly includes a single optical lens. In another embodiments, the lens assembly includes a plurality of optical lenses in an optical series.

At 610, during assembling of the camera device, an offset of the lens assembly along the optical axis relative to a support assembly is determined such that, when the camera device is oriented with a rotated optical axis positioned along a defined direction (e.g., orthogonal to gravity), the lens assembly is positioned at a neutral position relative to the image sensor without activation applied to the lens assembly. The neutral position may correspond to a target position where the lens assembly is focused at a hyperfocal distance, i.e., the neutral position may be a target distance between the lens assembly and the image sensor. During assembling of the camera device, the support assembly coupled to the lens assembly and the carrier may control the offset of the lens assembly along the optical axis. The support assembly may comprise a lens support and an actuator support.

The offset may be determined based at least in part on an effective BFL of the lens assembly. Alternatively or additionally, the offset may be determined based at least in part on a displacement of a carrier of the lens assembly under gravity at an upward posture of the camera device, and the displacement depends on a weight of the carrier and a stiffness of a spring of an actuator coupled to the lens assembly. Alternatively or additionally, the offset may be determined based at least in part on a displacement between the lens assembly and the carrier at a forward posture of the camera device, and the displacement depends on a weight of the actuator and a spring constant of the actuator. Alternatively or additionally, the offset may be determined based in part on an expected thermal shift of the lens assembly along the rotated optical axis at an operating temperature of the camera device within a defined temperature range.

At 615, during assembling of the camera device, the lens assembly is positioned within the camera device to be in an optical series with an image sensor of the camera device and to have the determined offset along the optical axis.

### Additional Configuration Information

The foregoing description of the embodiments has been presented for illustration; it is not intended to be exhaustive or to limit the patent rights to the precise forms disclosed. Persons skilled in the relevant art can appreciate that many modifications and variations are possible considering the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A camera device comprising:
an image sensor; and
a lens assembly in an optical series with the image sensor, wherein during assembling of the camera device,
the lens assembly is assembled within the camera device to have an optical axis parallel to gravity and positioned to have an offset along the optical axis relative to a support assembly, and
the offset is determined such that, when the camera device is oriented with a rotated optical axis orthogonal to gravity, the lens assembly is positioned at a neutral position relative to the image sensor without activation applied to the lens assembly.

2. The camera device of claim 1, wherein the neutral position corresponds to a target position where the lens assembly is focused at a hyperfocal distance.

3. The camera device of claim 1, wherein the neutral position corresponds to a target distance between the lens assembly and the image sensor.

4. The camera device of claim 1, wherein the offset is determined during assembling of the camera device based in part on an expected thermal shift of the lens assembly along the rotated optical axis at an operating temperature of the camera device within a defined temperature range.

5. The camera device of claim 1, wherein, during assembling of the camera device, the support assembly coupled to the lens assembly controls the offset along the optical axis.

6. The camera device of claim 1, wherein the offset is determined during assembling of the camera device based at least in part on an effective back focal length of the lens assembly.

7. The camera device of claim 1, wherein the support assembly comprises a lens support and an actuator support.

8. The camera device of claim 1, wherein:
the offset is determined during assembling of the camera device based at least in part on a displacement of a carrier of the lens assembly under gravity at an upward posture of the camera device; and
the displacement depends on a weight of the carrier and a stiffness of a spring of an actuator coupled to the lens assembly.

9. The camera device of claim 1, wherein:
the offset is determined during assembling of the camera device based at least in part on a displacement between the lens assembly and a carrier of the lens assembly at a forward posture of the camera device; and
the displacement depends on a weight of an actuator coupled to the lens assembly and a spring constant of the actuator.

10. The camera device of claim 1, wherein the camera device is part of a smartwatch.

11. A method of assembling a camera device, the method comprising:
assembling a lens assembly within the camera device to have an optical axis parallel to gravity;
determining an offset of the lens assembly along the optical axis relative to a support assembly such that, when the camera device is oriented with a rotated optical axis orthogonal to gravity, the lens assembly is positioned at a neutral position relative to the image sensor without activation applied to the lens assembly; and
positioning the lens assembly within the camera device to be in an optical series with an image sensor of the camera device and to have the determined offset along the optical axis.

12. The method of claim 11, wherein the neutral position corresponds to a target position where the lens assembly is focused at a hyperfocal distance.

13. The method of claim 11, wherein the neutral position corresponds to a target distance between the lens assembly and the image sensor.

14. The method of claim 11, further comprising:
determining the offset during assembling of the camera device based in part on an expected thermal shift of the lens assembly along the rotated optical axis at an operating temperature of the camera device within a defined temperature range.

15. The method of claim 11, further comprising:
controlling, during assembling of the camera device, the offset along the optical axis using the support assembly coupled to the lens assembly.

16. The method of claim 11, further comprising:
determining the offset during assembling of the camera device based at least in part on an effective back focal length of the lens assembly.

17. The method of claim 11, further comprising:
determining the offset during assembling of the camera device based at least in part on a displacement of a carrier of the lens assembly under gravity at an upward posture of the camera device, the displacement depending on a weight of the carrier and a stiffness of a spring of an actuator coupled to the lens assembly.

18. The method of claim 11, further comprising:
determining the offset during assembling of the camera device based at least in part on a displacement between the lens assembly and a carrier of the lens assembly at a forward posture of the camera device, the displacement depending on a weight of an actuator coupled to the lens assembly and a spring constant of the actuator.

19. A wristband system comprising:
a camera device including an image sensor and a lens assembly in an optical series with the image sensor, wherein during assembling of the camera device,
the lens assembly is assembled within the camera device to have an optical axis parallel to gravity and positioned to have an offset along the optical axis relative to a support assembly, and
the offset is determined such that, when the camera device is oriented with a rotated optical axis orthogonal to gravity, the lens assembly is positioned at a neutral position relative to the image sensor without activation applied to the lens assembly.

20. The wristband system of claim 19, wherein the offset is determined during assembling of the camera device based at least in part on an expected thermal shift of the lens assembly along the rotated optical axis at an operating temperature of the camera device within a defined temperature range.
